(19) United States
(12) Patent Application Publication
(10) Pub. No.: US 2024/0394824 A1
(43) Pub. Date: Nov. 28, 2024

(54) SYSTEMS AND METHODS FOR CONSISTENT RIDESHARING MANAGEMENT

(71) Applicant: VIA TRANSPORTATION, INC., New York, NY (US)

(72) Inventors: Shmulik MARCOVITCH, Kfar Saba (IL); Shiran EZRA, Ramat Gan (IL); Shahar CHEN, Tel Aviv (IL); Rotem BARNEA, Tel Aviv-Yafo (IL); Ben BAR-OR, Degania Alef (IL); Omer ZUQERT, Hulda (IL)

(73) Assignee: VIA TRANSPORTATION, INC., New York, NY (US)

(21) Appl. No.: 18/670,102

(22) Filed: May 21, 2024

Related U.S. Application Data
(60) Provisional application No. 63/503,557, filed on May 22, 2023.

(51) Int. Cl. G06Q 50/47; G06Q 10/0631

(52) U.S. Cl. CPC G06Q 50/47; G06Q 10/06313

(57) ABSTRACT

A system and method for consistent ridesharing planning is provided. The system and method can include ridesharing planning with one or more desired rides including one or more consistency requirements. The consistency requirements can be ridesharing requirements that are not changed during rideshare planning, even when additional rides are added to the plan. The rides can be added to the plan individually and consistency can be verified.

### CROSS REFERENCE TO RELATED APPLICATIONS

This application claims the benefit of and priority to U.S. Provisional Patent Application No. 63/503,557, filed May 22, 2023, the entire contents of which are owned by the assignee of the instant application and incorporated herein by reference in their entirety.

### FIELD OF THE INVENTION

The invention relates generally to vehicle ridesharing and systems and methods for ridesharing management.

### BACKGROUND OF THE INVENTION

Recent years have witnessed increasing interest and development in the field of vehicle sharing, where one or more riders may share the same vehicle for a portion of their rides. Ridesharing may save ride costs, increase vehicle utilization, and reduce air pollution. A rider may use a ridesharing service through a ridesharing service application accessed by the rider's mobile device.

Ridesharing service can be performed with a car, van, and/or bus. Ridesharing service can include scheduling pickup-drop offs of riders, determining routes for vehicles, modifying routes for vehicles on the fly. Ridesharing services can operate as fixed route, semi-fixed route, and/or full point-to-point services, and vehicles can be commanded to operate in any of those modes and/or be switched between those service types.

A ridesharing management system can include a system to manage a fleet of vehicles. The system to manage the fleet of vehicles can include a user interface. The ridesharing management system can include algorithms to schedule the fleet to optimize performance of the fleet. The ridesharing management system can provide a user interface for an operator to interact with the ridesharing management system through. A rider and/or driver can have an application (e.g., a app on a smartphone or tablet) to communicate with the ridesharing management system. The rider can schedule ride services via the app, and the driver can communicate information (e.g., current location, pickup time, availability, drop off time) to the ridesharing management system via its app. In some embodiments, the rider can schedule daily and/or weekly rides on a schedule for a set duration of time. In some embodiments, the driver app can instruct the driver to pickup, drop off locations, and/or specific routes to take.

The ridesharing management system can be presented to one or more operators (e.g., people or other computing systems) that manage the fleet of vehicles via a screen and/or data output. For example, the ridesharing management system can be used to manage a paratransit fleet, a school bus fleet, or any type of fleet as is known in the art.

Typically, there are two types of ridesharing management system, one that is wholly manual, allowing for an operator to direct each driver in a fleet (e.g., add a particular ride, pickup and drop off, certain shift of the driver), and second that is wholly automated where an operator is not involved.

In some embodiments, it can be desirable to allow for a hybrid ridesharing management system that provides ridesharing plans to operators and allows operators to manually modify the plans. For example, in a school bus ridesharing system, an operator may want to ensure that a certain rider is put with a certain bus driver because the bus driver has a relationship with the rider, and for some children riders having a relationship with the driver can be important. This can lead to some parameters for ride requests being consistent.

Therefore, it can be desirable for consistent rideshare planning, which allows for some or all rides to have some or all of the parameters defined as consistent.

### SUMMARY

Advantages of the invention can include an ability to have consistency with rides.

In one aspect, the invention includes a system for managing a fleet of ridesharing vehicles. The system can include a communications interface configured to receive a desired ride, wherein the desired ride can include a pick-up location, a drop-off location, a desired pick-up time, a desired drop-off time and at least one of the pick-up location, the drop-off location, the desired pick-up time, the desired drop-off time is a consistency requirement. The system can include a processor configured to determine an assignment per desired ride to be inserted into a ridesharing plan for a plurality of days. Determining the set of proposed rides can involve for each ride of the set of desired rides, determine a pick-up window based on the pick-up time and a drop-off window based on the drop-off time. Determining the set of proposed rides can also involve for each ride of the set of desired rides, determine for a first day of the plurality of days, a ridesharing plan based on the pick-up window, the drop-off window, and the consistency requirement for all plurality of rides that are requested for the first day. Determining the set of proposed rides can also involve for each ride of the set of desired rides, for each of the plurality of days but the first day, determine a ridesharing plan by applying the ridesharing plan for rides with the consistency requirement on the first day and planning the remaining rides around the applied consistent rides. The processor can also be configured to transmit to the communications interface the ridesharing plan.

In some embodiments, the plurality of days is a week. In some embodiments, the first day is randomly selected from the plurality of days or a day within the plurality of days that has the most desired rides. In some embodiments, each ride is assigned in an order that is based on a user input, based on time, or any combination.

In another aspect, the invention involves a method for managing a fleet of ridesharing vehicles. The method involves receiving, via a communications interface, a desired ride, wherein the desired ride can include a pick-up location, a drop-off location, a desired pick-up time, a desired drop-off time and at least one of the pick-up location, the drop-off location, the desired pick-up time, the desired drop-off time is a consistency requirement. The method involves determining, via a processor, an assignment per desired ride to be inserted into a ridesharing plan for a plurality of days. Determining the set of proposed rides comprises for each ride of the set of desired rides, determining, via the processor, a pick-up window based on the pick-up time and a drop-off window based on the drop-off time. Determining the set of proposed rides also comprises for each ride of the set of desired rides, determining, via the processor, for a first day of the plurality of days, a ridesharing plan based on the pick-up window, the drop-off window, and the consistency requirement for all plurality of rides that are requested for the first day. Determining the set of proposed rides comprises for each ride of the set of desired rides, for each of the plurality of days but the first day, determining, via the processor, a ridesharing plan by applying the ridesharing plan for rides with the consistency requirement on the first day and planning the remaining rides around the applied consistent rides. The method can also involve transmitting, via the processor, to the communications interface the ridesharing plan.

The method can also involve the plurality of days is a week. The method can also involve the first day is randomly selected from the plurality of days or a day within the plurality of days that has the most desired rides. The method can also involve each ride is assigned in an order that is based on a user input, based on time, or any combination.

In another aspect, the invention involves a system for managing a fleet of ridesharing vehicles. The system includes a communications interface configured to receive a set of desired rides, wherein each ride of the set of desired rides can include a pick-up location, a drop-off location, a desired pick-up time, a desired drop-off time and at least one of the pick-up location, the drop-off location, the desired pick-up time, the desired drop-off time is a consistency requirement. The system also includes a processor configured to determine a ridesharing plan for a plurality of days, wherein determining the ridesharing plan comprises. The processor is also configured to for each ride of the set of desired rides, determine a pick-up window based on the pick-up time and a drop-off window based on the drop-off time. The system also includes a processor configured to for each ride of the set of desired rides i) determine a particular shift of a plurality of shifts and a location within the particular shift to add the particular ride to based on minimizing a wait time for a vehicle assigned to the shift, a minimum start time for all shifts, and a maximum end time for all shifts, ii) apply a discrete optimization algorithm to finalize the particular shift and a location within the particular shift to the determination in step i), iii) perform a consistency check algorithm on the output of the machine learning algorithm to verify adding the particular ride to the shift as determined in step i) does cause any violations and iv) if adding the particular ride to the shift as determined in step causes a violation, return to step i), otherwise, continue adding the rides of the set of rides to the shifts until all of the plurality of rides are assigned. The processor is also configured to transmit to the communications interface the ridesharing plan.

In some embodiments, each time a new ride is added, the prior position of the preexisting rides in the ridesharing plan do not change. In some embodiments, the plurality of days is a week. In some embodiments, the fleet of ridesharing vehicles is school buses.

In another aspect, the method involves a method for managing a fleet of ridesharing vehicles. The method can involve receiving, by a communications interface, a set of desired rides, wherein each ride of the set of desired rides can include a pick-up location, a drop-off location, a desired pick-up time, a desired drop-off time and at least one of the pick-up location, the drop-off location, the desired pick-up time, the desired drop-off time is a consistency requirement. The method can involve determining, via a processor, a ridesharing plan for a plurality of days. Determining the ridesharing plan can involve for each ride of the set of desired rides, determining, via the processor, a pick-up window based on the pick-up time and a drop-off window based on the drop-off time. Determining the ridesharing plan can involve for each ride of the set of desired rides i) determining, via the processor, a particular shift of a plurality of shifts and a location within the particular shift to add the particular ride to based on minimizing a wait time for a vehicle assigned to the shift, a minimum start time for all shifts, and a maximum end time for all shifts, ii) applying, via the processor, a discrete optimization algorithm to finalize the particular shift and a location within the particular shift to the determination in step i), iii) performing, via the processor, a consistency check algorithm on the output of the machine learning algorithm to verify adding the particular ride to the shift as determined in step i) does cause any violations, and iv) if adding the particular ride to the shift as determined in step causes a violation, returning to step i), otherwise, continuing to adding the rides of the set of rides to the shifts until all of the plurality of rides are assigned. The method can also involve transmitting, via the processor, to the communications interface the ridesharing plan.

In some embodiments, each time a new ride is added, the prior position of the preexisting rides in the ridesharing plan do not change. In some embodiments, the plurality of days is a week. In some embodiments, the fleet of ridesharing vehicles is school buses.

The foregoing general description and the following detailed description are exemplary and explanatory only and are not restrictive of the claims.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a diagram of a ridesharing management system, according to some embodiments of the invention.

FIG. 2 shows an example of an architecture for a ridesharing management server, according to some embodiments of the invention.

FIG. 3 is a flowchart for a method for managing a fleet of ridesharing vehicles, according to some embodiments of the invention.

FIG. 4 is a flowchart for a method for managing a fleet of ridesharing vehicles, according to some embodiments of the invention.

FIG. 5 is an example of an interface for a consistent ridesharing management system, according to some embodiments of the invention.

FIG. 6 is an example of an interface for the consistent ridesharing management system after being run with the inputs from FIG. 5, according to some embodiments of the invention.

FIG. 7 is an example of an interface a ridesharing plan for an example consistent ridesharing management system, according to some embodiments of the invention.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

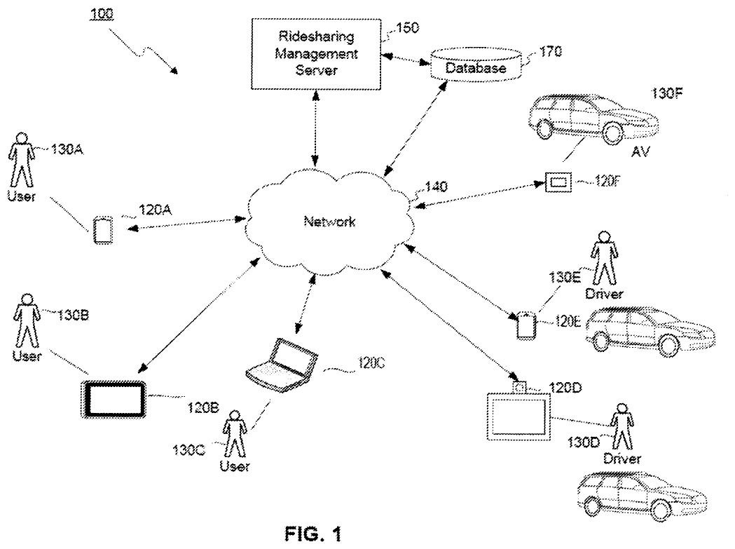

FIG. 1 is a diagram of a ridesharing management system 100, according to some embodiments of the invention. The ridesharing management system 100 includes one or more user devices 120A-120F (collectively referred to as user devices 120) associated with respective users 130A-130F, a network 140, a ridesharing management server 150, and a database 170. The user devices 120 can be mobile communications devices.

The users 130A-130F can be riders, drivers and/or other computing systems. In FIG. 1, users 130A-130C are riders, users 130D-130E are drivers, and user 130F is an autonomously driven vehicle user. The user devices 120A-120F can be associated with riders, drivers, and/or other computing systems, such that user devices 120A-120C can be referred to as rider devices, 120D-120E can be referred to as driver devices, and user device 120F can be referred to as a driving-control device.

The network 140 can be coupled to the user devices 120 to facilitate communications between the user devices 120 and the ridesharing management server 150. For example, the rider 130A can request a ride via the rider device 120A that is a smart phone. The request can be transmitted by the user device 120A to the ridesharing management server 150 through the network 140. The ridesharing management server 150 can transmit a route to the driver device 120E to instruct the driver 130E to pick-up the rider 130A. The ridesharing management server 150 can transmit a message to the rider 130A via the rider device 120A indicating that the driver 130E is on its way and the message can instruct the rider 130A to a particular pick-up location.

The network 140 can facilitate communications that include receiving ride requests and/or other ride related input from or sending confirmations to the rider devices 120A-120C and/or sending ride service assignments to the driver devices 120D-120E and driving-control device 120F.

The network 140 can be any type of network that provides communications, exchanges information, and/or facilitates the exchange of information between ridesharing management server 150 and user devices 120. For example, network 140 can be the Internet, a Local Area Network, a cellular network, a public switched telephone network (“PSTN”), and/or other suitable connection(s) that enables ridesharing management system 100 to send and/or receive information between the components of the ridesharing management system 100. The network 140 can be wired and/or wireless depending on the type of connection to the network 140. Although the network 140 is shown herein as a cloud, the network 140 can include a variety of computing components, including wired and wireless components that in various networked configurations to facilitate desired communication between components.

The network 140 can support a variety of messaging formats as is known in the art, and may support a variety of services and applications for user devices 120. For example, the network 140 can support navigation services for user devices 120, such as directing users and/or ridesharing service vehicles to pick-up and/or drop-off locations.

The ridesharing management server 150 can be a system that communicates with and/or is part of a communication service provider which provides a variety of data or services, such as voice, messaging, real-time audio/video, to users, such as users 130A-130E. The ridesharing management server 150 can be a computer-based system including computer system components, desktop computers, workstations, tablets, handheld mobile communications devices, memory devices, and/or internal network(s) connecting the components.

The ridesharing management server 150 can receive information from user devices 120 over the network 140, process the information, store the information, and/or transmit information to mobile communications devices 120 over network 140. The ridesharing management server 150 can receive ride requests from user devices 120A-120C. The ridesharing management server 150 can send ride confirmation and/or ride fare information to user devices 120A-120C. The ridesharing management server 150 can send ride service assignments (e.g., including pick-up and/or drop-off location information) to driver devices 120D and 120E, and driving-control device 120F.

The ridesharing management server 150 can receive user input from user devices 120A-120C. For example, the ridesharing management server 150 can receive various ride service parameters, such as walking distance to a pick-up location, maximum delay of arrival/detour, and/or maximum number of subsequent pick-ups.

The rideshare vehicle can be a car, van, SUV, truck, bus or any kind of vehicle suitable for human transportation. In some embodiments, a vehicle is a taxi. In some embodiments, a rideshare vehicle can be an autonomous vehicle, wherein a control device integrated with the vehicle or a management system separate from the vehicle can send operational messages. In some embodiments, all of the ridesharing vehicles are busses (e.g., school busses).

The ridesharing management server 150 can calculate ride fares based on a solo portion of a user's ride and a shared portion of the ride. The ride fare calculation can be based on various ride service parameters set by the user, such as the walking distance involved in the ride, and/or user selection regarding toll road usage.

The database 170 may include one or more physical and/or virtual storages coupled with the ridesharing management server 150. The database 170 can store user account information (e.g., registered rider and/or driver accounts) and/or corresponding user profiles (e.g., contact information, profile photos, and/or associated mobile communications device information). User account information for a rider can include ride history, service feedback, complaints, and/or comments. User account information for a driver can include number of ride service assignments completed, ratings, and/or ride service history information. The database 170 can store various ride requests received from user devices 120A-120C. Each ride request can include a corresponding starting point and desired destination information, user input regarding various service parameters, pick-up and drop-off locations, time of pick-up and drop-off, ride fares, and/or other user feedback (e.g., user comments).

The database 170 may include traffic data, maps, and/or toll road information, which may be used for ridesharing service management. The traffic data may include historical traffic data and/or real-time traffic data regarding a certain geographical region. The traffic data may be used to determine traffic conditions. Traffic data and traffic conditions can be used to estimate pick-up and drop-off times for riders and/or determine an optimal route for a particular ride or for all rides. The real-time traffic data may be received from a real-time traffic monitoring system, which may be integrated into or independent from ridesharing management system 100.

The maps may include map information (e.g., roads, streets and/or distances) typically used for navigation purposes. The map information can be used to determine potential routes and in transit routes for the rideshare vehicles and/or guiding the users to a pick-off or drop-off location. Guiding the users to a pick-up or drop off location can include displaying a map, outputting audio, displaying a list of directions or any combination thereof. The in transit routes can be modified based on adding or reducing passengers, the driver driving off the route, speed and/or other updates. Toll road information may include amount of toll charges regarding certain roads, and any change or updates thereof. Toll road information may be used to calculate ride fares. In some embodiments, a rider can specify that the rideshare vehicle route avoids toll roads.

The data stored in database 170 can be transmitted to the ridesharing management server 150 for accommodating ride requests. In some embodiments, the database 170 is stored in a cloud-based server (not shown) that is accessible by the ridesharing management server 150 and/or user devices 120 through the network 140. In some embodiments, the database 170 reside within the ridesharing management server 150.

The database 170 can include a list of ridesharing vehicles with their corresponding shift availability. The shift availability can include day, start time, stop time, maximum shift duration, and/or labor rules associated with the respective driver for the shift. The shift availability can be input by a user (e.g., a ridesharing provider).

During operation, the ridesharing management server 150 can communicate with the driving-control device 120F to direct the autonomous vehicle 130F to pick up and drop off riders 130A-130C. In some embodiments, autonomous vehicles capable of detecting objects on the road and navigate to designated locations may be utilized for providing ridesharing services.

In various embodiments, the ridesharing management server 150 is implemented on a single server or on multiple servers. Each server can be on a single computing device or distributed among multiple computing devices. In various embodiments, the ridesharing management system 100 includes multiple ridesharing management servers, and each ridesharing management server can serve a category of ridesharing services, ridesharing services associated with a certain category of service vehicles, and/or ridesharing services in a specific geographical region. For example, a first ridesharing management server can direct a first fleet of vehicles, a second ridesharing management server can direct a second fleet of vehicles and a third ridesharing server can direct a third fleet of vehicles. The first, second and third fleet of vehicles can be on-demand services, fixed-route services, or any combination thereof.

In some embodiments, a plurality of ridesharing management servers collectively provides a dynamic and integrated ridesharing service system.

As shown in FIG. 1, users 130A-130E may include a plurality of users 130A-130C, and a plurality of drivers 130D and 130E, who may communicate with one another, and with ridesharing management server 150 using various types of user devices 120 that are mobile communications devices. For example, the mobile communications device can include a display such as a television, tablet, computer monitor, video conferencing console, or laptop computer screen. A mobile communications device 120 can further include video/audio input devices such as a microphone, video camera, keyboard and/or web camera. A mobile communications device 120 can include mobile devices such as a tablet or a smartphone having display and/or video/audio capture capabilities. The mobile communications device can include one or more software applications that can facilitate the mobile communications devices to engage in communications, such as IM, VOIP, video conferences. For example, user devices 130A-130C can send requests to ridesharing management server 150, and receive confirmations therefrom. Drivers 130D and 130E can use their respective user devices to receive ride service assignments and navigation information from ridesharing management server 150, and may contact the users with their respective user devices.

In some embodiments, a user may directly hail a vehicle by hand gesture or verbal communication, such as traditional street vehicle hailing. In such embodiments, once a driver accepts the request, the driver can use his respective user device to input the ride request information. Ridesharing management server 150 can receive the information, and accordingly assign one or more additional ride service assignments to the same vehicle, for example, subsequent ride requests received from other user devices 120 through network 140.

In some embodiments, driver devices 120D and 120E, and driving-control device 120F may be embodied in a vehicle control panel, as a part of the vehicle control system associated with a particular vehicle. For example, a traditional taxi company may install a drive device in all taxi vehicles managed by the taxi company. In some embodiments, driver devices 120D and 120E, and driving-control device 120F, may be further coupled with a payment device, such as a card reader installed as a part of the vehicle control panel or as a separate device associated with the vehicle. A user may then use the payment device as an alternative payment mechanism. For example, a user who hails the taxi on the street may pay through the payment device, without using a user device providing ridesharing service.

In some embodiments, the rideshare management server 150 can receive a list of ride requests from a user (e.g., a rideshare provider, not shown). The consistent rideshare management system can receive the list of ride requests for a predefined time period, e.g., at night for the following day, for a scheduled 24 period, or any defined time period. Each ride in the list of ride requests can include a pick-up location, drop-off location, desired pick-up time, desired drop off time, maximum delay between desired pick-up time and actual pick-up time, maximum delay between desired drop off time and actual drop-off time, maximum distance between pick-up location and actual pick-up location, maximum distance between drop-off location and actual drop-off location, or any combination thereof. In some embodiments, one or more of the rides can specify any of its parameters as being consistent. A consistent parameter can be a parameter that is not changed. For example, if the maximum delay between desired drop off time and actual drop-off time is indicated as consistent, then it may not be changed during ridesharing planning in order to, for example, accommodate another ride.

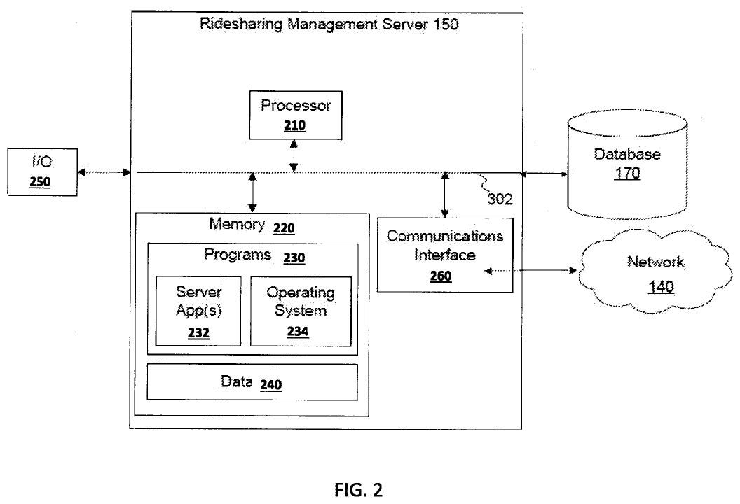

FIG. 2 shows an example of an architecture for a ridesharing management server 150, according to some embodiments of the invention. The ridesharing management server 150 can include a processor 210 may be one or more processing devices configured to perform functions of the disclosed methods, such as a microprocessor manufactured by Intel™ or manufactured by AMD™. Processor 210 can include a single core or multiple core processors executing parallel processes simultaneously. For example, processor 210 may be a single core processor with virtual processing technologies. In some embodiments, processor 210 can use logical processors to simultaneously execute and/or control multiple processes. Processor 210 can implement virtual machine technologies, and/or other technologies to provide the ability to execute, control, run, manipulate, and/or store multiple software processes, applications, programs. In some embodiments, processor 210 includes a multiple-core processor arrangement (e.g., dual and/or quad core) to provide parallel processing functionalities to allow ridesharing management server 150 to execute multiple processes simultaneously. It is appreciated by one of ordinary skill in the art that other types of processor arrangements can be implemented that provide for the capabilities disclosed herein.

Memory 220 can be a volatile or non-volatile, magnetic, semiconductor, tape, optical, removable, non-removable, or other type of storage device or tangible or non-transitory computer-readable medium that stores one or more program(s) 230 such as server apps 232 and operating system 234, and data 240. Common forms of non-transitory media include, for example, a flash drive, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The ridesharing management server (e.g., ridesharing management server 150 as described above in FIG. 1) can include one or more storage devices configured to store information used by processor 210 (or other components) to perform certain functions related to the embodiments. For example, the ridesharing management server may include memory 220 that includes instructions to enable processor 210 to execute one or more applications, such as server apps 232, operating system 234, and/or any other type of application or software known to be available on computer systems. In some embodiments, the instructions, and/or application programs, can be stored in an external database 170, which in some embodiments, is internal to ridesharing management server 150, or external storage communicatively coupled with ridesharing management server 150 (not shown), such as one or more database or memory accessible over network 140.

Database 170 or other external storage may be a volatile or non-volatile, magnetic, semiconductor, tape, optical, removable, non-removable, or other type of storage device or tangible or non-transitory computer-readable medium. Memory 220 and database 170 may include one or more memory devices that store data and instructions used to perform one or more features of the disclosed embodiments. Memory 220 and database 170 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, ridesharing management server 150 is communicatively connected to one or more remote memory devices (e.g., remote databases (not shown)) through network 140 or a different network. The remote memory devices can be configured to store information that ridesharing management server 150 can access and/or manage. By way of example, the remote memory devices may include document management systems, Microsoft SQL database, SharePoint databases, Oracle™ databases, Sybase™ databases, or other relational databases. Systems and methods consistent with disclosed embodiments, however, are not limited to separate databases or even to the use of a database.

Programs 230 may include one or more software modules causing processor 210 to perform one or more functions of the disclosed embodiments. Processor 210 may execute one or more programs located remotely from one or more components of the ridesharing management system 100. For example, ridesharing management server 150 may access one or more remote programs that, when executed, perform functions related to disclosed embodiments.

In some embodiments, server app(s) 232 may cause processor 210 to perform one or more functions of the disclosed methods. For example, devices associated with users, drivers and autonomous vehicles may respectively be installed with user applications for vehicle ridesharing services, and driver applications for vehicle ridesharing services. Further, a mobile communications device may be installed with both the driver applications and the user applications, for uses in corresponding situations.

In some embodiments, other components of ridesharing management system 100 may be configured to perform one or more functions of the disclosed methods. For example, mobile communications devices 120 may be configured to calculate estimate pick-up and drop-off times based on a certain ride request and may be configured to calculate estimate ride fares. As another example, mobile communications devices 120 may further be configured to provide navigation service, and location service, such as directing the user to a particular pick-up or drop-off location and providing information about a current location of the respective user or vehicle to ridesharing management server 150.

In some embodiments, program(s) 230 may include operating system 234 performing operating system functions when executed by one or more processors such as processor 210. By way of example, operating system 234 may include Microsoft Windows™, Unix™, Linux™, Apple™ operating systems, Personal Digital Assistant (PDA) type operating systems, such as Apple IOS, Google Android, Blackberry OS, Microsoft CE™, or other types of operating systems. Accordingly, the disclosed embodiments may operate and function with computer systems running any type of operating system 234. Ridesharing management server 150 may also include software that, when executed by a processor, provides communications with network 140 through communications interface 260 and/or a direct connection to one or more user devices 120. Specifically, communications interface 260 may be configured to receive ride requests (e.g., from user devices 120A-120C) headed to differing destinations, or a volume of ride requests and receive indications of the current locations of the ridesharing vehicles (e.g., from driver devices 120D and 120E or driving-control device 120F). In one example, communications interface 260 may be configured to continuously or periodically receive current vehicle location data for the plurality of ridesharing vehicles that are part of ridesharing management system 100. The current vehicle location data may include global navigation satellite system (GNSS) data and/or local navigation satellite system data generated by at least one GNSS component of a mobile communications device 120 associated with each ridesharing vehicle. The GNSS data can include Global Positioning System (GPS), GLONASS, Galileo, or any GNSS system as is known in the art.

In some embodiments, data 240 may include, for example, profiles of users, such as user profiles or driver profiles. User profiles can include contact information, profile photos, user account information and/or associated mobile communications device information. Rider account information can include ride history, service feedback, complaints, and/or comments. Driver account information can include number of ride service assignments completed, ratings, ride service history, rider ride history, driver service record, and/or communications between a driver and a rider regarding a particular ride request. In some embodiments, data 240 may further include traffic data, toll road information, and navigation information, which may be used for handling and accommodating ride requests.

Automated ridesharing dispatch system 300 may also include one or more I/O devices 250 having one or more interfaces for receiving signals or input from devices and providing signals or output to one or more devices that allow data to be received and/or transmitted by automated ridesharing dispatch system 300. For example, automated ridesharing dispatch system 300 may include interface components for interfacing with one or more input devices, such as one or more keyboards, mouse devices, and the like, that enable automated ridesharing dispatch system 300 to receive input from an operator or administrator (not shown).

In some embodiments, it can be desirable for consistent rideshare planning which can allow flexibility to decide what the values of the plan parameter are to optimize the values until the plan is provided, where some of the parameters can be flexible and others are not. A consistent parameter for a rideshare is one that is highly important it is not changed. For example, in some ridesharing management systems, a rider can request to be dropped off at first time, however, in the interest of efficiency and picking up the most riders, the rider can be scheduled to be dropped off before or after the first time. A consistent parameter can be one in which the rider must be dropped off at the first time within a threshold or a violation is generated. Some riders can be indicated as not being allowed to have violations.

The ridesharing management system can allow an operator to book, review, manage and/or optimize the students and/or riders needs (or do these things automatically), the driver and/or vehicle supply and optimize the routing schedule (e.g., to find the best routing schedule) considering the calendar going forward.

Providing a consistent ridesharing plan can be desirable for school busses, para transit rides, elderly ridesharing and/or any scenario where having certain parameters consistent is desired. In some embodiments, riders can pay a premium to have consistent parameters honored.

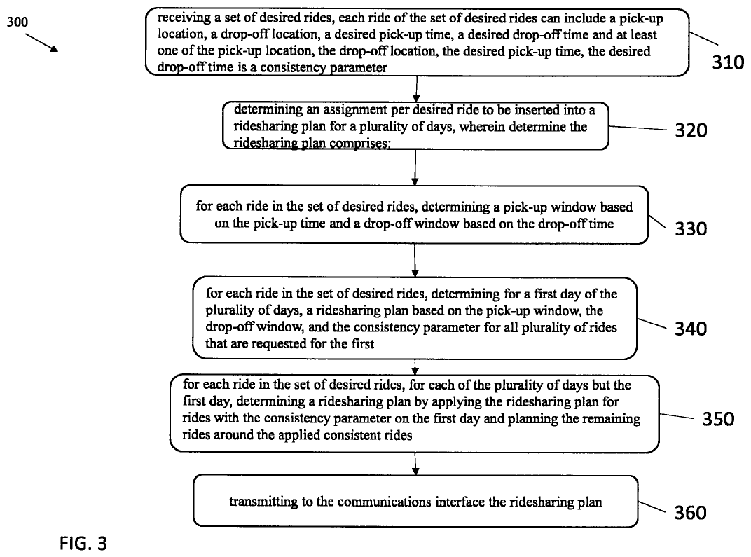

FIG. 3 is a flowchart for a method for managing a fleet of ridesharing vehicles, according to some embodiments of the invention. In some embodiments, a ridesharing management system can manage a fleet of ridesharing vehicles that includes paratransit rides. Paratransit rides can include consistency requirements (e.g., ride requirements that cannot be changed during ridesharing planning). In general, each ridesharing request that is received is added to an existing ridesharing plan. The existing ridesharing plan can have no current rides or many current rides. The existing ridesharing plan can have rides with consistency requirements (e.g., time and/or location). For a plurality of rides, the plurality of rides can be looped through one by one to be added to the plan, and/or the rides that have been assigned with consistency requirements can be maintained.

The method can also involve receiving, via a communications interface, a set of desired rides, wherein each desired ride can include a pick-up location, a drop-off location, a desired pick-up time, a desired drop-off time and at least one of the pick-up location, the drop-off location, the desired pick-up time, the desired drop-off time is a consistency requirement (Step 310). The set of desired rides can be one or more than one.

The pick-up location can be the location that a rider is requesting to be picked-up. The drop-off location can be the location the rider is requesting to be dropped off. The desired pick-up time can be a time the rider is requesting to be picked-up. The desired drop-off time can be the time the rider is requesting to be dropped off. One or more of the foregoing parameters can be designated as requiring consistency.

For example, paratransit riders may request rides with consistency requirements. For example, a paratransit ride can have a maximum amount of time it is allowed to be late for drop off, which can cause the drop-off time to be a consistency requirement. In another example, the paratransit ride having a pick-up location of a doctor office, can have a maximum allowable wait time for pick-up, causing the pick-up time to be a constancy parameter.

The method can also involve determining, via a processor, an assignment per desired ride to be inserted into a ridesharing plan for a plurality of days (Step 320). The plurality of days can be input by a user. The plurality of days can be any desired interval, for example, a week, a month, a weekend, a particular day of the week for a month (e.g., every Monday), or any desired plurality of days as input by a user.

In some embodiments, when receiving a plurality of desired rides, an order of adding the plurality of rides to the ridesharing plan can be set. The order can be input by a user, based on time, based on an order specified by the system or any combination.

Determining the ridesharing plan for the plurality of days can include, for each ride in the set of desired rides, determining a pick-up window based on the pick-up time and a drop-off window based on the drop-off time (Step 330). The pick-up window can be based on an allowed difference between the input pick-up time and an actual pick-up time. The allowed difference can be how many minutes before or after the actual pick-up time can take place. The allowed difference can be a user input, a default value, based on a condition of the paratransit rider, or any combination thereof.

In some embodiments, additional parameters can be included with the desired rides. In some embodiments, the actual pick-up and actual drop-off location is not the same as desired pick-up and the desired drop off location. For example, it can be desirable to have an actual pick-up and/or an actual drop-off location that limits road crossing or limits the distance of walking.

In some embodiments, a ride can include parameters of driver, vehicle type, max duration in the vehicle, and/or wait location (e.g., whether the driver can pickup right at the pick-up location or must pick-up nearby due to some constraint, for example, no parking in front of the building or no school bus parking on the block). In some embodiments, parameters can include vehicle requirements, such as, air conditioner, oxygen mask, space for a wheel chair, space for groceries, reclining seats, sun roof, etc. In some embodiments, the parameter can be a particular assistant that rides with the driver, or other type of rider.

The method can also involve determining, via the processor, for each ride in the set of desired rides, for a first day of the plurality of days, a ridesharing plan based on the pick-up window, the drop-off window, and the consistency requirement for all plurality of rides that are requested for the first day based on an existing ridesharing plan, a default ridesharing plan or any combination thereof. (Step 340). The ridesharing plan can exist (e.g., as cumulated during the ridesharing planning by adding rides one by one or received as input), and then each new ride request can be added one by one.

The first day can be selected from the plurality of days. The first day can be a day that has the most ride requests from the set of desired rides. The first day can be randomly selected from the plurality of days.

In some embodiments, one or more of the rides schedules for the first day can have consistency requirements while others may not. For example, assume a first ride that has a consistency requirement causing a time window for pick-up between 12:00 and 12:15. When scheduling a second ride, the first ride cannot have its pick-up window moved in order to accommodate the second ride, although the drop-off window may be moved, if its is not designated as a constancy parameter. If the pick-up window of the second ride is also a consistency requirement and the pick-up window and pick-up location of the second ride results in an inability for the vehicle to make it to the second ride within the second ride's pick-up window, then a second ride can be assigned to a second vehicle, otherwise, the second ride can be assigned to the same vehicle as the first ride, assuming there is space in the second vehicle. A third, fourth, and/or n'th number of rides, where n is an integer, can be added to the first day shift based on a number of vehicles available in the fleet and shift times of each of the vehicles.

Each ride can be added to the ridesharing plan as shown in U.S. Pat. No. 9,562,785, incorporated herein by reference in its entirety.

In this manner, one or more vehicle in the ridesharing fleet can have a plan (e.g., a route plan) for pick-ups and drop-offs for the first day. The route plan can specify the time windows and locations for pick-up and drop-off for the rides. In some embodiments, the route plan

[symbol]

The method can also involve for each of the plurality of days but the first day (e.g., as the first day has already been scheduled in step 340), determining a ridesharing plan by applying the ridesharing plan for rides with the consistency requirement on the first day and planning the remaining rides around the applied consistent rides (Step 350). For example, a particular rider can have a ride request for multiple days, e.g., Monday, Wednesday, and Friday. If the first day is Monday, then the plan assigned to that rider for Monday, assuming the rider's ride for Monday had at least one consistency requirement (e.g., pick-up window of 12:00-12:15), then that ride can be automatically assigned to Wednesday and Friday. In this manner, all of the rides with a consistency requirement for the first day including multiple days can be reassigned to the same scheduled time slot on the other days. In various embodiments, a same vehicle, same driver, different vehicle, different driver or any combination thereof can be assigned to planned route.

In this manner, one or more vehicle in the ridesharing fleet can have a plan (e.g., a route plan) for pick-ups and drop-offs for each day in the plurality of days.

In some embodiments, instead of determining a ridesharing plan for a first day and then applying to the remaining days, the method can involve determining a ridesharing plan for each day independently, determining which days have the most shifts in common and selecting that day as the basis for the the days to create the consistent ridesharing plan. Having a shift in common can require that the time and/or location overlaps.

The method can also involve transmitting to the communications interface the ridesharing plan (Step 360).

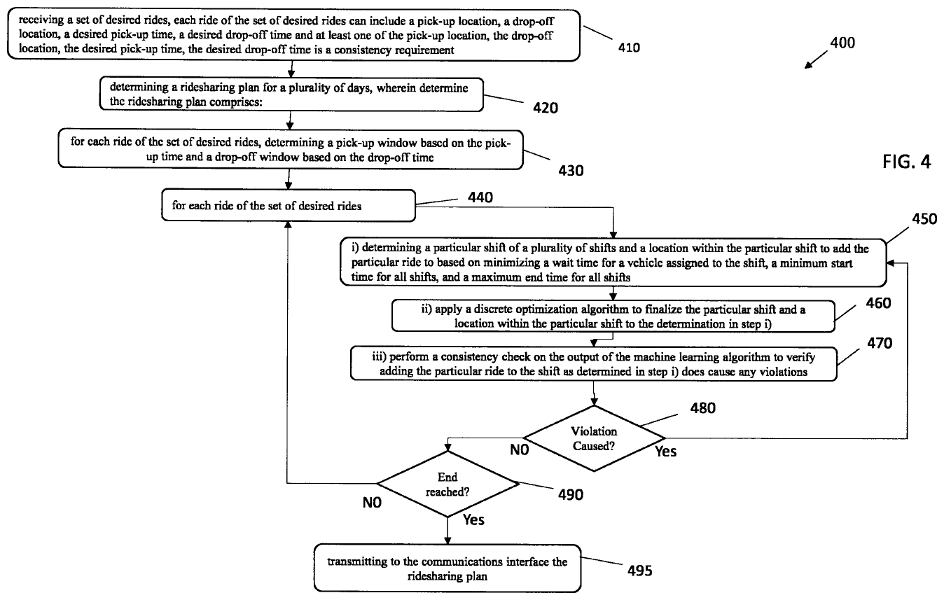

FIG. 4 is a flowchart for a method for managing a fleet of ridesharing vehicles, according to some embodiments of the invention. In some embodiments, a ridesharing management system can manage a fleet of ridesharing vehicles that includes a school bus system. a school bus system can include consistency. In general, a plurality of ridesharing requests is added to a ridesharing plan for a plurality of ridesharing vehicles (e.g., school busses).

For school busses, typically riders (e.g., students) are going to the same schools five days a week, the schools starts at the same time, end at the same time, the students typically get picked up and dropped off at the same locations. However, in some embodiments, there may be some variation. For example, a child in a divorced household may get picked up and dropped off at one parents house in a first location two days a week, and the other parents house in a second location three days a week. A child with different learning needs may need to attend a different school one day a week may and that different school may have a different start and end time. In these embodiments, two different consistency rides can be created for the same rider.

In some embodiments, rideshare vehicles can arrive at drop off locations prior to parent caregiver pickups and allow for some wait time of the vehicle. In some embodiments, rideshare vehicles can arrive at the drop off location such that there is no wait time to avoid having other children in the bus to have to wait.

Each ridesharing request that is received can be added to an existing ridesharing plan one by one, by determining where to position the ride in the ridesharing plan while maintaining consistency requirement requirements of the rides that already exist in the plan. The existing ridesharing plan can have no current rides or many current rides. For a plurality of rides, they can be looped through one by one to be added to the plan, and/or the rides that have been assigned with consistency requirements can be maintained.

The method can involve receiving, vi a communications interface, a set of desired rides, wherein each ride of the set of desired rides can include a pick-up location, a drop-off location, a desired pick-up time, a desired drop-off time and at least one of the pick-up location, the drop-off location, the desired pick-up time, the desired drop-off time is a consistency requirement (Step 410). In some embodiments, additional parameters can be included with the desired rides (e.g., particular driver, particular vehicle type). In some embodiments, the actual pick-up and actual drop-off location is not the same as desired pick-up and the desired drop off location. For example, it can be desirable to have an actual pick-up and/or an actual drop-off location that limits road crossing or limits the distance of walking.

In some embodiments, a ride can include parameters of driver, vehicle type, max duration in the vehicle, and/or wait location (e.g., whether the driver can pickup right at the pick-up location or must pick-up nearby due to some constraint, for example, no parking in front of the building or no school bus parking on the block

In some embodiments, time, e.g., a desired pick-up time, a desired drop-off time requires consistency, thus these are the parameters assigned as consistency requirements. In some embodiments, route and time require consistency, thus the desired pick-up time, a desired drop-off time, pick-up location, and a drop-off location are the parameters assigned as consistency requirements.

In some embodiments, time consistency is an exact time or a time range. In some embodiments, location consistency is an exact location or a location range (e.g., up to 100 ft from a particular location).

The method can also involve determining, via a processor, a ridesharing plan for a plurality of days (Step 420). The plurality of days can be input by a user. The plurality of days can be any desired interval, for example, a week, a month, a weekend, a particular day of the week for a month (e.g., every Monday), or any desired plurality of days as input by a user.

Determining the ridesharing plan for the plurality of days can include, for each of the set of desired rides, determining a pick-up window based on the pick-up time and a drop-off window based on the drop-off time (Step 430). The pick-up window can be based on an allowed difference between the input pick-up time and an actual pick-up time. The allowed difference can be how many minutes before or after the actual pick-up time can take place. The allowed difference can be a user input or a default value.

The method can involve for each of the set of desired rides (Step 440):
i) determining a particular shift of a plurality of shifts and a location within the particular shift to add the particular ride to based on minimizing a wait time for a vehicle assigned to the shift, a minimum start time for all shifts, and a maximum end time for all shifts (Step 450). The minimum start time for all shifts can be input by a user. For example, for a school bus system, the minimum start time for all shifts can be 6:00 am, 6:15 am, 6:30 am or any time relative to the start of the school day. The maximum end time for all shifts can be an input by a user. For example, for a school bus system, the maximum end time can be 4:30 pm, 4:45 pm, 5:00 pm, or any end time relative to an end of the school day. The plurality of shifts can be based on a number of available ridesharing vehicles in the ridesharing management system. For example, a number of school buses available for school bus driving to school and/or home from school. The number of school buses available for school bus driving to school can be the same or different then the number of school buses available for driving home from school. Determining the particular shift can be done on a ride by ride basis where each ride is added to the same shift, time and location in each of the plurality of days simultaneously. If the ride can't be added to all of the days (e.g., adding the ride causes another ride in the plan to be violated), then the shift, time and/or location for the ride can be moved in order to try to add the ride to a different shift, time and/or location. If there is no shift to accommodate the ride, then the ride can be rejected. Each shift can be a route, e.g., a route a school bus driver takes to pick up at the beginning of the school day or drop off at the end of the school day;
ii) applying a discrete optimization algorithm or a graph optimization algorithm to finalize the particular shift and a location within the particular shift to the determination in step i) (Step 460). The discrete optimization algorithm or the graph optimization algorithm can be finalize the particular shift and location relative to the determination made in step i) in order to minimize cost. The cost can be a wait time of all riders on a shift and/or driving time of a vehicle. The discrete optimization algorithm can be as shown in U.S. Pat. No. 9,562,785, incorporated herein by reference in its entirety. The discrete optimization algorithm can be a dynamic trip-vehicle assignment.
iii) performing a consistency check algorithm on the output of the machine learning algorithm to verify adding the particular ride to the shift as determined in step i) does cause any violations (Step 470). A violation can be a ride placement in a shift that causes a consistency requirement of another ride to be violated.
iv) if adding the particular ride to the shift as determined in step causes a violation (Step 480), return to step i). Returning to step i) can cause the particular ride to be skipped in the planning or the particular ride to run through the algorithm again. Running the particular ride through the algorithm again can cause the particular ride to no longer cause a violation. In some embodiments, there is a maximum amount of time the particular ride can be run through the algorithm before it is discarded (e.g., 3, 4, 5 times). If adding the particular ride to the shift does not cause a violation (Step 480) then, continue adding the rides of the plurality of rides to the shifts until all of the plurality of rides are assigned until the end is reached (Step 490); and
v) The method can also involve transmitting to the communications interface the ridesharing plan (Step 490).

In some embodiments, the ridesharing plan (e.g., schedule for all of the desired rides) can be determined by assigning each rider (e.g., student) a max duration for their ride (e.g., a worst case scenario for the pick-up time and drop-off time) based on all parameters and consistency requirements for each student. The max duration calculated can be a latest time to get to the rider pickup considering all the days, and the latest time that occurs to get to the rider dropoff.

The ridesharing plan can be done for predetermined intervals, for example, one week, or two weeks. In some embodiments, multiple consistent plans are managed at the same time. For example, there can be a summer semester and a fall semester, where consistent values can be different.

In some embodiments, a consistency window can be used. The consistency window can define an allowed difference between an earliest and latest assignment time of the same rides between weekdays (e.g., pickup and dropoff tasks, separately). While the size of the consistency window can be fixed, the start time of the window itself can be dynamic, and can change based on the current assignment times. For example, assume rides are assigned for pickup at 8:30 on Mon, at 8:32 on Tue, and at 8:44 on Wed, The difference between 8:44 and 8:30 is 14 minutes. If the consistency window size is 30 minutes, this means the consistency requirement is met. If the consistency window size is 5 minutes, this means the consistency requirement is not met. In some embodiments, a violation of the consistency requirement can be allowed (e.g., by a admin or as determined by the system).

If the consistency window is violated, there can be a recalculation for the request denial of the request and/or there can be a warning.

In some embodiments, there can be route consistency requirements. If the route consistency is violated, there can be a recalculation for the request, denial of the request and/or a warning. In some embodiments, a user input can override the consistency requirement. For example, if it an output is displayed to a user that a consistency violation has occurred, a user can input that the consistency violation be allowable.

In some embodiments, there is a consistency score. The consistency score can be an overall score for the ridesharing plan for all of the rides. The consistency score can be the number of violations for the ridesharing plan plus a sum of all of the delays in time. The system can aim towards a zero consistency score. For a non-zero consistency score, a warning can be transmitted to the operator. The operator can be presented with a list of the violations. The ridesharing management system can allow violations and/or attempt to reschedule to minimize violations. In some embodiments, the operator can input which violations can remain and which violations are unacceptable. If the operator indicates a violation is unacceptable, the ridesharing management system can resequence without causing a violation for the rides that the operator indicated are unacceptable and/or if that is not possible, output another warning to the operator.

In some embodiments, if new students enter the system, the operator can request that the student's ride be entered without causing a disruption to the plan. In some embodiments, the new rider can cause a delay and the operator can chose whether to allow that delay or not. In some embodiments, before a consistency value is promised the system can change other riders time or location as long as it is changed in a consistent way. This may not be considered a delay since the system is still in the consistent planning phase. For example, there can be cases where the operator may choose to add the request in a manner that forces a consistency break to the new requests and/or other riders.

There can be a case where a request is added after a consistent commitment was given to a rider or caregiver. In this case the system attempts to maintain the consistency (e.g., that is already fixed) but may propose delays that the operator can choose to communicate or not.

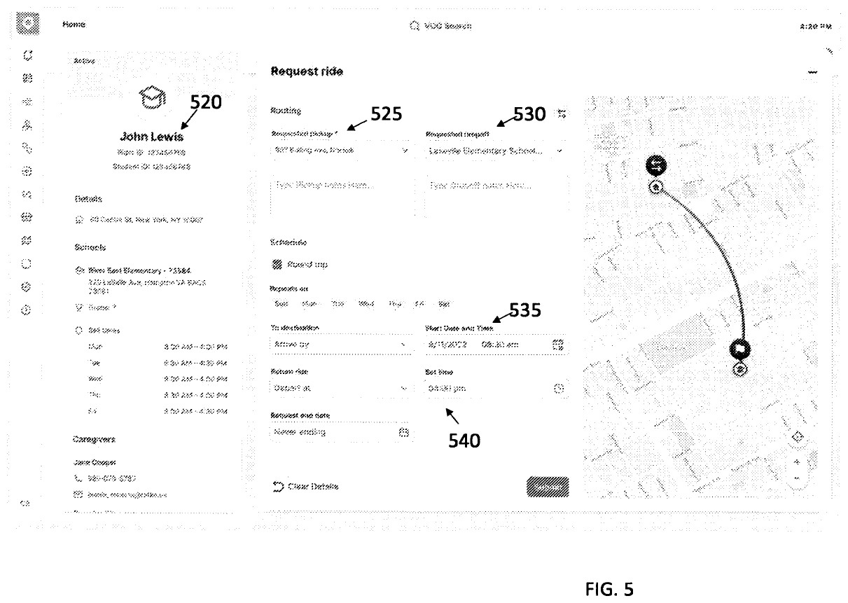

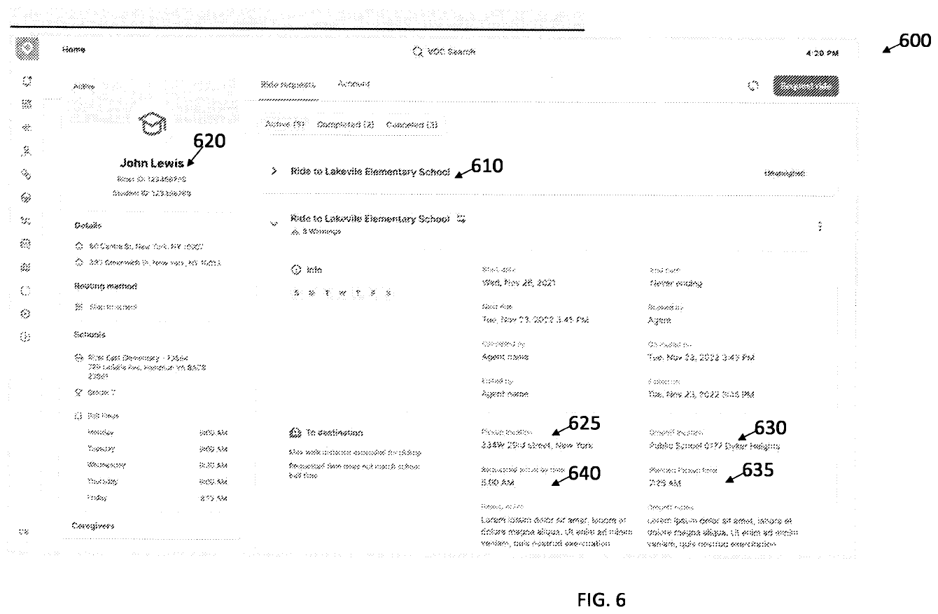

FIG. 5 is an example of an interface 500 for a consistent ridesharing management system, according to some embodiments of the invention. As can be seen in FIG. 6, rideshare management planning is being performed to Lakeville Elementary School. The Rider is John Lewis having pick-up location input 525, drop-off location input 530, arrive by time for morning pickup 535, and arrive by time for afternoon drop off 545.

FIG. 6 is an example of an interface 600 for the consistent ridesharing management system after being run with the inputs from FIG. 5, according to some embodiments of the invention. As can be seen in FIG. 6, rideshare management planning a pick-up location 625, drop-off location 630, pick-up time 635, and drop-off time 640 have been indicated, and three warnings have been generated 645.

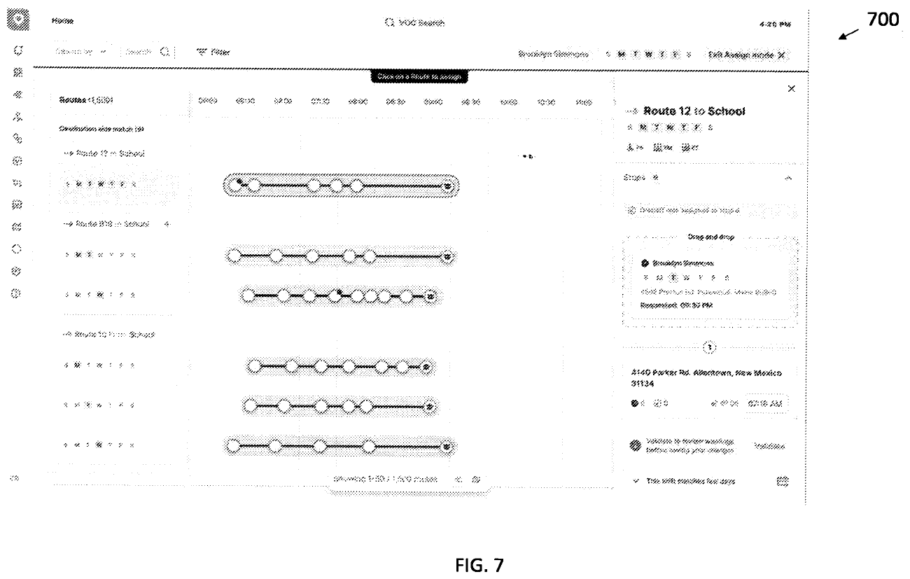

FIG. 7 is an example of an interface 700 a ridesharing plan for an example consistent ridesharing management system, according to some embodiments of the invention. In FIG. 7 there are three ridesharing vehicles, each having associated planned routes. Route 12 has a start time of approximately 6:00 am and an end time of approximately 9:00 am with five pick-ups, Monday through Friday. Route 919 has two shifts (e.g., two planned routes) one set of rides on Monday and Tuesday and another set of rides on Wednesday. Route 10 has three sets of rides, one on Monday, one on Tuesday and a Third on Wednesday.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above-described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A system for managing a fleet of ridesharing vehicles, the system comprising:
a communications interface configured to receive a desired ride, wherein the desired ride can include a pick-up location, a drop-off location, a desired pick-up time, a desired drop-off time and at least one of the pick-up location, the drop-off location, the desired pick-up time, the desired drop-off time is a consistency requirement; and
a processor configured to:
determine an assignment per desired ride to be inserted into a ridesharing plan for a plurality of days, wherein determine the set of proposed rides comprises:
for each ride of the set of desired rides, determine a pick-up window based on the pick-up time and a drop-off window based on the drop-off time;
for each ride of the set of desired rides, determine for a first day of the plurality of days, a ridesharing plan based on the pick-up window, the drop-off window, and the consistency requirement for all plurality of rides that are requested for the first day;
for each ride of the set of desired rides, for each of the plurality of days but the first day, determine a ridesharing plan by applying the ridesharing plan for rides with the consistency requirement on the first day and planning the remaining rides around the applied consistent rides;
transmit to the communications interface the ridesharing plan.

2. The system of claim 1 wherein the plurality of days is a week.

3. The system of claim 1 wherein the first day is randomly selected from the plurality of days or a day within the plurality of days that has the most desired rides.

4. The system of claim 1 wherein each ride is assigned in an order that is based on a user input, based on time, or any combination.

5. A method for managing a fleet of ridesharing vehicles, the method comprising:
receiving, via a communications interface, a desired ride, wherein the desired ride can include a pick-up location, a drop-off location, a desired pick-up time, a desired drop-off time and at least one of the pick-up location, the drop-off location, the desired pick-up time, the desired drop-off time is a consistency requirement; and
determining, via a processor, an assignment per desired ride to be inserted into a ridesharing plan for a plurality of days, wherein determine the set of proposed rides comprises:
for each ride of the set of desired rides, determining, via the processor, a pick-up window based on the pick-up time and a drop-off window based on the drop-off time;
for each ride of the set of desired rides, determining, via the processor, for a first day of the plurality of days, a ridesharing plan based on the pick-up window, the drop-off window, and the consistency requirement for all plurality of rides that are requested for the first day;
for each ride of the set of desired rides, for each of the plurality of days but the first day, determining, via the processor, a ridesharing plan by applying the ridesharing plan for rides with the consistency requirement on the first day and planning the remaining rides around the applied consistent rides;
transmitting, via the processor, to the communications interface the ridesharing plan.

6. The method of claim 5 wherein the plurality of days is a week.

7. The method of claim 5 wherein the first day is randomly selected from the plurality of days or a day within the plurality of days that has the most desired rides.

8. The method of claim 5 wherein each ride is assigned in an order that is based on a user input, based on time, or any combination.

9. A system for managing a fleet of ridesharing vehicles, the system comprising:
a communications interface configured to receive a set of desired rides, wherein each ride of the set of desired rides can include a pick-up location, a drop-off location, a desired pick-up time, a desired drop-off time and at least one of the pick-up location, the drop-off location, the desired pick-up time, the desired drop-off time is a consistency requirement; and
a processor configured to:
determine a ridesharing plan for a plurality of days, wherein determining the ridesharing plan comprises:
for each ride of the set of desired rides, determine a pick-up window based on the pick-up time and a drop-off window based on the drop-off time;
for each ride of the set of desired rides:
i) determine a particular shift of a plurality of shifts and a location within the particular shift to add the particular ride to based on minimizing a wait time for a vehicle assigned to the shift, a minimum start time for all shifts, and a maximum end time for all shifts,
ii) apply a discrete optimization algorithm to finalize the particular shift and a location within the particular shift to the determination in step i)
iii) perform a consistency check algorithm on the output of the machine learning algorithm to verify adding the particular ride to the shift as determined in step i) does cause any violations,
iv) if adding the particular ride to the shift as determined in step causes a violation, return to step i), otherwise, continue adding the rides of the set of rides to the shifts until all of the plurality of rides are assigned; and
transmit to the communications interface the ridesharing plan.

10. The system of claim 9 wherein each time a new ride is added, the prior position of the preexisting rides in the ridesharing plan do not change.

11. The system of claim 9 wherein the plurality of days is a week.

12. The system of claim 9 wherein the fleet of ridesharing vehicles is school buses.

13. A method for managing a fleet of ridesharing vehicles, the method comprising:
receiving, by a communications interface, a set of desired rides, wherein each ride of the set of desired rides can include a pick-up location, a drop-off location, a desired pick-up time, a desired drop-off time and at least one of the pick-up location, the drop-off location, the desired pick-up time, the desired drop-off time is a consistency requirement; and
determining, via a processor, a ridesharing plan for a plurality of days, wherein determining the ridesharing plan comprises:
for each ride of the set of desired rides, determining, via the processor, a pick-up window based on the pick-up time and a drop-off window based on the drop-off time;
for each ride of the set of desired rides:
v) determining, via the processor, a particular shift of a plurality of shifts and a location within the particular shift to add the particular ride to based on minimizing a wait time for a vehicle assigned to the shift, a minimum start time for all shifts, and a maximum end time for all shifts,
vi) applying, via the processor, a discrete optimization algorithm to finalize the particular shift and a location within the particular shift to the determination in step i)
vii) performing, via the processor, a consistency check algorithm on the output of the machine learning algorithm to verify adding the particular ride to the shift as determined in step i) does cause any violations,
viii) if adding the particular ride to the shift as determined in step causes a violation, returning to step i), otherwise, continuing to adding the rides of the set of rides to the shifts until all of the plurality of rides are assigned; and
transmitting, via the processor, to the communications interface the ridesharing plan.

14. The method of claim 13 wherein each time a new ride is added, the prior position of the preexisting rides in the ridesharing plan do not change.

15. The method of claim 13 wherein the plurality of days is a week.

16. The method of claim 13 wherein the fleet of ridesharing vehicles is school buses.
